(19) United States
(12) Patent Application Publication
(10) Pub. No.: US 2005/0105397 A1
(43) Pub. Date: May 19, 2005

(54) System and method for a clock using a time standard where global time works cooperatively with all local time zones

(76) Inventor: Christopher Tuason, Houston, TX (US)

Correspondence Address: Christopher Tuason, 1447 Pirates Cove, Houston, TX, 77058, US

(21) Appl. No.: 10/989,707

(22) Filed: Nov. 15, 2004

Related U.S. Application Data
(60) Provisional application No. 60/520,006, filed on Nov. 14, 2003.

(51) Int. Cl. H04B 7/185; G04B 19/22

(52) U.S. Cl. 368/21

(57) ABSTRACT

A global time reckoning system simultaneously indicates local time and global time. The global time reckoning system can be practiced with standard clock timer drivers, including electromechanical and digital clock motors, in combination with a novel global time system clock face to allow a user to reckon time locally or anywhere on the globe without time zone conversion calculations. The global time system clock face has multiple time scales, at least one of which is driven by the clock drive in cooperation with an hour indicator (e.g., an hour hand). The global time system clock face simultaneously displays global time (relative to any location on the globe) and local time. Additionally, the global time reckoning system, with the appropriate clock timer driver is adaptable to indicate a number of other global time related information, including sunrise/sunset, days of the week, lunar phase and solstices/equinoxes.

### FIELD OF THE INVENTION

The present invention is in the field of time measuring systems and devices. More specifically, the present invention relates to time measuring systems utilizing timepieces having means to display the absolute or relative time for more than one of the 24 divisions of the globe which approximately coincide with meridians at successive hours wherein the Sun is at its zenith.

### BACKGROUND OF THE INVENTION

The need to be able to simultaneously reckon both local time and global time persists to current times. Shannon (U.S. Pat. No. 4,579,460) proposed a synchronous world clock that used a rotating polar map of the world relative to a stationary 24-hour time scale ring to reckon time. Time was set by aligning one of twenty-four world time zones on the map to its correct time on the time scale ring. After that, the indication for a specific time in a particular time zone was read from the position of the time zone relative to the time scale ring. A user's local time was determined by the user's (time zone) location on the map. However, this time reckoning system is based on the Coordinated Universal Time (UTC) time convention and can be inaccurate in situations where not all global locations are using the same reference time, e.g., standard time versus savings time.

Other world time reckoning means have been proposed in the field. For example, Wright (U.S. Pat. No. 5,146,436) discloses a universal world clock for indicating UTC and fast time at any geographical location in the world. Lu (U.S. Pat. No. 5,107,468) discloses a 24-hour world clock, and Loaiza (U.S. Pat. No. 6,603,709) discloses a world globe as a time keeping device.

Although each of these teachings may be useful for its intended purpose, it is still beneficial to the field to have a new global time system standard without the limitations (including social and geopolitical limitations) of the UTC system. It would be especially useful to have a standard time reckoning system that additionally can provide both local and global time simultaneously for a user any where on the globe. A number of standards for accomplishing such have been invented. However, many require a conversion from common local time that is extremely complex, with decimal time standards that date back to at least the French Revolutionary period being one such exemplary type of standard. One example of a recently invented global time standard that requires complex translation to common local time is “New Earth Time”, as it is based upon non-conformal divisions of longitudinal degrees and minutes of Sun transit.

Alternatively, there are systems of global time standardization that translate readily between global and local time without requiring any complex mathematical conversion to the ubiquitous hours and minutes of local time, wherein minutes specified in global time translate directly to minutes in local time without any need for conversion.

Currently, the most popular such system uses the previously mentioned UTC standard (as it has been derived from the previously most popular standard of GMT). A critical flaw in systems using the UTC standard is that the local hour-angle of the Sun observed at Greenwich, England (and its associatively designated “Prime Meridian” of zero degrees in longitude), is expressed globally in terms of the number-hour of local Greenwich time. Such number-hours relate the angle of the Sun as it is observed in a planar reference of a flatly extended local horizon. Such standards that use this method of attempting to extend a flat local plane across all reaches of a round globe inherently create interference with the local hour-angles experiences at other longitudes.

A limited solution to such problem was invented by the Canadian, Sanford Fleming, and subsequently proposed in his paper titled, “Uniform Non-Local Time (Terrestrial Time)”, as delivered in his presentation to the Canadian Institute in November, 1876, of which standard he later referred to by the name, “Cosmic Time”.

Fleming arrived at the ingenious solution of taking the reference origin for global time off of an arbitrary point on the surface of a flatly extended Earth (Greenwich being one of many such origins commonly used during the 1800s) and shifting it to the center point of the Earth so that no time zone would be given special status of dominating over the others. His means for doing so was simply to take the number-hour representation of Greenwich Mean Time and replacing it with a letter-hour representation of “Cosmic Time”. This simple solution works effectively because such letter-hour designations are not burdened with any local hour-angle association of flatly extended number-hour designations. Fleming's proposed standard also incorporated common minutes to designate global time, thereby easing the conversion with local time.

However, well over one hundred years have transpired without Fleming's standard being adopted. It is important to recognize its critical shortcomings so that it such issues can be solved with the global time standard of the present invention:

Fleming's standard lacked a method with an ability to translate between all local time zones and global time. This was not a problem that he encountered when he invented “Cosmic Time”, primarily, perhaps, because it preceded the adoption of standard time zone divisions, in use today, of one-hour per 15 degrees in longitude (which Sanford Fleming himself invented and proposed during the same period).

Furthermore, his invention lacked an ability to translate between special case time zone rules that dictate anomalous offsets from the basic standard, with two key examples of such being the geopolitical constructs of Daylight Savings Time as well as local time zones that dictate fractional-hour offsets from the global time.

Further still, his invention lacked clock embodiments that enabled the accomplishment of fluid translation between global time to local times of choice. While he did invent a 24-hour clock face embodiment that used his global standard, evidence is lacking for any embodiment that was not rigidly limited to the translation between only one local time zone.

Further still yet, his invention is lacking in evidence for a system or method to designate specific local time identifiers, as they are required to be uniquely distinguished from local times from other zones for any system that is capable of translating global time broadly into any and all local time zone, let alone his apparent limitation of translating to just one local time zone per clock embodiment.

His invention is also lacking for evidence of a 12-hour embodiment capable of any such translation of global time, let alone evidence for a would be anachronism of a digital clock embodiment.

The time standard and embodiments used by the present invention solve all such apparent limitations of Fleming's invention, and go further to specify numerous clock and Date-Time Group solutions that resolve issues such as those that currently hamper communications in our current age that includes space travel and the internet, where expansive time zones are transited in mere instants.

The current popular global time convention that is based upon Sun-angles relative to an extendly flat earth surface can have the effect of limiting our conception of time. The present invention can serve to expand such time conception beyond a local horizon toward a global perspective. In observing a sunset, say, one can muse upon the basic thought that the Sun is setting, bringing an end to the light of day, whereas a multidimensional concept of time can emphasize an awareness that while locally observing a sunset, the Sun is simultaneously shining straight overhead a different section of the globe, as specified by the letter-hour global time designation of the present invention. This is one small illustration of the potential benefits from a time system that works co-operatively between all local times throughout the Earth and a single global time that is valid everywhere, both on as well as off of the planet.

### SUMMARY OF THE INVENTION

The present invention includes a system for indicating time that uses a standard method of global time that works co-operatively with all local time zones, and uses either a 12-hour or a 24-hour analogue time display (clock face) or a digital clock display. The present time standard is usable at all locations on the globe with a clock display that provides for the reading global and local times simultaneously, thereby enabling clear and easy conversion between local and global time. With the Earth sectioned into 24 equal time zones that are sequentially lettered A-X with the Sun's relative East to West movement, the global standard hour is given simply by the letter of the zone that the Sun is overhead.

Unlike the current standard of Greenwich Mean Time (GMT), the global time standard of the present invention does not uphold any one particular time zone to have a special status above any of the others. There is only an arbitrary convention of starting the letter sequence at the line of 180 degrees of longitude, coinciding with the International Dateline. In other respects, all zones are treated equally to each other. The Sun's location with respect to the Earth as a whole has the same significance as a time reference to anyone at anyplace, whereas the local time in Greenwich, England, as indicated by GMT has significance heavily weighted to those who happen to live in that one time zone, forcing the vast majority who live outside of that zone into an unwieldy conversion problem.

The present invention enables global time to be read directly from the clock display with no need for conversion. 12-hour, 24-hour, and digital clock embodiments all use the present time standard that, along with enabling clear and easy translation between local and global time, encompasses means to translate between special time zone rules such as Daylight Savings Time, half-hour offsets and whole day offsets. The present time standard also specifies the manner for unambiguous Date-Time Group (DTG) which respects the fact that at every instant in time, the Earth as a whole exists with at least two days/dates.

The 12-hour clock display of the present invention reads like a common clock, with added markings for global time to be read directly from the clock face as labeled with sequential letters that correspond to each particular time zone that the Sun passes overhead in a 24-hour period. The A.M./P.M. hour ambiguity is resolved through the use of a spiral scale that is wrapped twice around the face of the 12-hour clock face and is marked to indicate the bright hours of daylight versus the dark hours of nighttime. Global time is read directly from a common minute hand and a common hour hand that points to the 24 letter-hours as marked in their corresponding clock position for the local hour of one specialized local time zone. The spiral hour scale can also be marked with other scheduled events of interest, including the times of sunrise and sunset.

The 24-hour clock embodiment of the present invention can graphically display the time of day for all zones across the globe by showing the Sun's relative position with its corresponding nighttime shadow through progressive clockwise rotation around a fixed clock face centered on a North Polar projection map of the Earth. The local time in each zone, as marked around the map in sequential global letter-hours A-X, can be read directly from the local hour ring of the display that moves in unison with the Sun pointer/hour hand, nighttime shadow along with a midnight pointer that indicates each zone's transition from one day to the next.

### BRIEF DESCRIPTION OF THE DRAWINGS

FIG. 1 is a graphical representation of a twenty-four hour clock embodiment that is practicable with the present invention that displays local time concurrently with GMT. The clock face is in a local-favored orientation with local noon at the top. The driven display components are the hour hand which rotates clockwise once every 24 hours and the minute hand which rotates clockwise once every 60 minutes. The inner ring of GMT hours can be adjusted to align with the corresponding local hours of one particular time zone.

FIG. 2 is a graphical representation of a twenty-four hour clock embodiment that is similar to that of FIG. 1, but the inner adjustable ring is labeled with global hours of the present invention instead of GMT. Also added are sunrise and sunset markers bars that are moved slowly throughout the yearly seasons to indicate the time of local sunrise and sunset.

FIG. 3 is similar to FIG. 2 but in a global-favored orientation with the zone for the global letter-hour “X”, associated with the International Dateline, located at the top. Additionally, a local hour ring marked with daytime and nighttime hours that rotates in unison with the hour hand to indicate the local time at any time zone. Also added are symbols for the Sun and a midnight pointer that move with the local hour ring as extensions of the hour hand.

FIG. 4 is similar to FIG. 3 with the addition of a North Polar projection map of the globe fixed at the center of the clock face. The map is sectioned into twenty-four equal zones corresponding to the global letter-hours “A” through “X”, with geopolitical time zones graphically depicted. The line marking the equator appears as a circle. The outer edge of the clock face is marked with an adjustable bezel that indicates the four quadrants of noon, 6 pm, midnight, and 6 am for one particular local time zone. Also, bars that move to mark local sunrise and sunset are added.

FIG. 5 is similar to FIG. 4 except that the clock face is shifted to a local-favored orientation, showing local noon for one particular time zone oriented at the top.

FIG. 6 depicts the features of an embodiment that move in unison with the hour hand.

FIG. 7 depicts a conversion chart that translates one global time into the various local times that span the globe.

FIG. 8 depicts the conversion chart of FIG. 7, except that it is modified to illustrate the particular local time zone, “gh”, that is offset by a half hour between the zones “G” and “H.”

FIG. 9 depicts a 12-hour clock embodiment of the present invention with a clock face showing a spiraled label that is marked with each local hour of the 24-hour day.

FIG. 10 is similar to FIG. 9 except that local number-hours are replaced by global letter-hours, shading is added to the spiral hour scale to distinguish day hours from night hours, and there are markers for sunrise, sunset and periods of twilight as they change throughout the year.

FIG. 11 is similar to FIG. 10 except that local number-hours instead of global letter-hours are used on the clock face spiral and that extra hour hands are included to indicate the local hour of two other time zones. All three hour hands move in unison. Also added is a centrally located day-of-the-week indicator that makes one full clockwise rotation every week.

FIG. 12 is similar to FIG. 10 with the addition of an annual calendar showing months of the year with an Earth symbol that makes one fill clockwise rotation every year as displayed in concert with the day-of-the-week indicator similar to that shown in FIG. 11.

FIG. 13 is similar to FIG. 12 except that the clock face has global hours that are shifted by one hour for Central Daylight Time, as is practiced in the United States.

### DETAILED DESCRIPTION OF THE INVENTION

The present invention is a novel global time standard that is usable at substantially all geographic locations with the disclosed clock face designs wherein global and local times are read simultaneously so that conversion effort is minimized. The present global time standard is based on a system that tracks the Sun's position with respect to the Earth as a whole, instead of the local time at one isolated time zone, and it uses a frame of reference that is aligned to the International Dateline without requiring any other particular time zone (e.g. GMT) to have a special time referencing status above the rest.

The global time of the present invention is specified by the position of the mean sunn with respect to the Earth. The mean sunn, defined herein as the “sunn”, is a Sun construct that has uniform motion that is synchronized to the uniform motion of a clock's hour hand (the difference between the motion of the sunn and the apparent motion of the Sun as observed from a point on the Earth's surface is specified by the “equation of time”). Time is organized in the present invention by marking the passage of the sunn over longitude lines that are divided into fifteen degree sections corresponding to the twenty-four hours of a day, equating to the 360 degree rotation in each day (with respect to the sunn) with each hour divided into sixty equal minutes and each minute divided into sixty equal seconds so that the global standard of the present invention incorporates conventional local time standards with reduced effort in translation between the two.

The twenty-four equal sections of the globe are designated with the letters “A” through “X”, ending at the International Dateline. If the sunn is overhead “X”, then the time is “X”, or X:00 to be precise. To indicate both local time as well as global time for clear and easy translation, the global hour is displayed as a prefix to the local hour. Take the example:
X18:00
   The global time is “X” concurrently with the local time being 1800 (or 6 pm). The matching of global to local time fixes the local geographic zone, in this case, to the time zone “R”. Conversely, when it is 1600 hours in time zone “R”, the global time is X:00, indicating that the sunn is overhead zone “X.”

To eliminate the need for such a calculation, local times can be designated with a suffix that identifies the particular time zone being used. The suffix is simply the letter designation of the time zone being used. Using this global-hour prefix and time-zone suffix, translation between global and local time is demonstrated in the further example:
L6:08 R (6:08 am in Houston, Tex. time zone “R” with the sunn overhead Greenwich, England, “L”)

While other well-ordered sets of characters could alternatively have be used to label time zones (thereby designating global hours), the Roman alphabet is used because of its familiarity and convenient set size of 26, which includes one letter for each of the 24 sequential zones as well as two more letters that are used to identify those local zones that are offset by one whole day, creating in essence a wrapped set of time zones that extends before and after the set of 24 designated geographic zones (as distinct from geopolitical zones).

Referring now to the drawings, the details of preferred embodiments of the present invention are graphically and schematically illustrated. Like elements in the drawings are represented by like numbers, and any similar elements are represented by like numbers with a different lower case letter suffix.

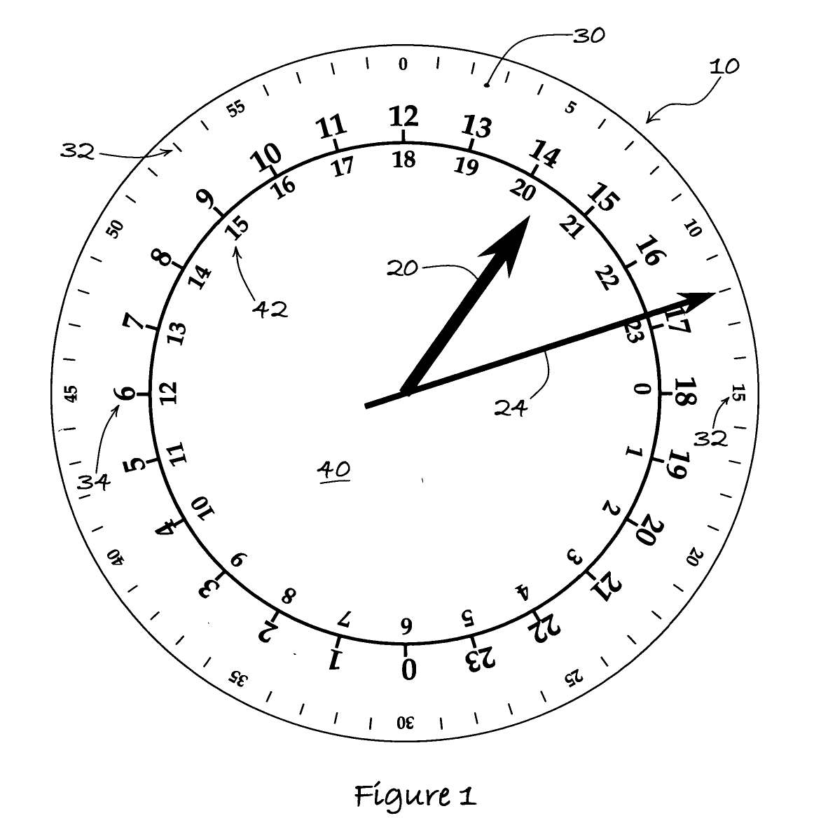

The figures in part represent an increasingly more detailed disclosure of a preferred embodiment of the present time standard. FIG. 1 is a graphical representation of a clock face 10 divided into twenty-four hours. The clock face 10 is drawn with an adjustable inner ring/circle 40 marked with global time scale 42 oriented, for this example, for the Central Standard Time (CST) zone, with the GMT scale labeled on the inner or global time scale 42 in numerals and CST time scale labeled on the middle or local time scale 34 in numerals and minutes on the outer scale 32 in numerals on the outer ring 30. The local time scale 34 is oriented with noon in the locale at the top of the scale (i.e., the 12 o'clock position). The moving parts of the clock face 10 of FIG. 1 include the hour hand 20 which rotates clockwise once every 24 hours. Also the minute-hand 24 rotates clockwise once every sixty minutes as in an ordinary analogue clock face.

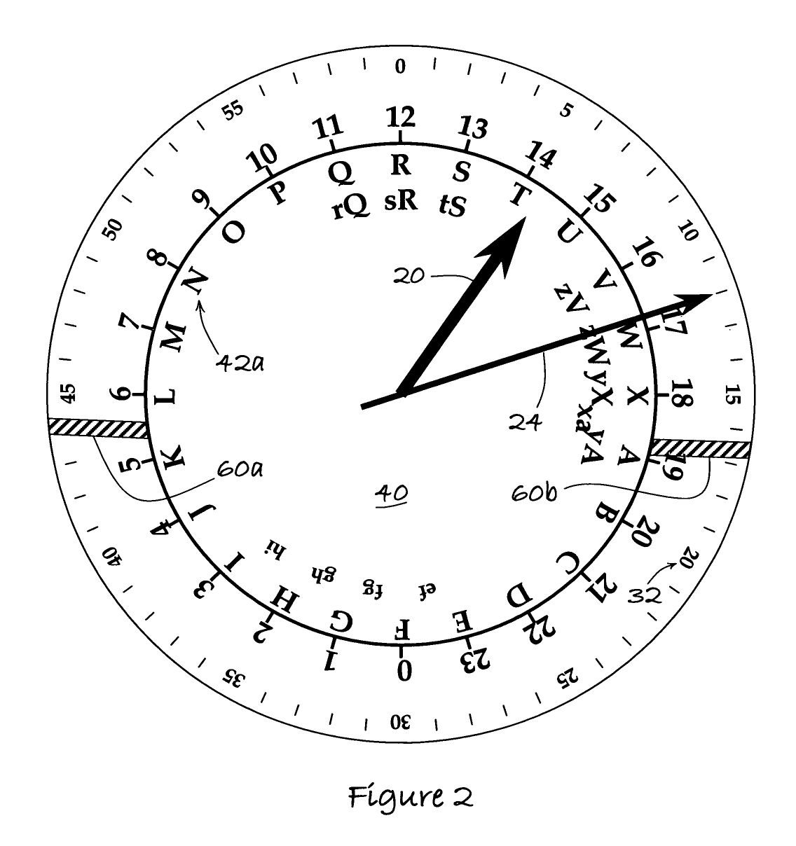

FIG. 2 is a graphical representation of a 24-hour clock face 10 embodiment of the present invention with the local time scale 34 having numbered hours referenced in this example for the CST time zone and the global time scale 42a having lettered hours. Sunrise and sunset markers (bars) 60a & 60b are located to coincide with local sunrise and sunset, and with the appropriate clock/watch driver, they are disposed to move slowly throughout the year in correlation with actual changing sunrise and sunset times. Also marked concentrically on the global time scale 42a are “letter pairs” that are used to identify three types of special local time zone rules. The first is used to indicate a shift away from the geographically designated time zone, as is done with Daylight Savings Time. For example, the letter pair “rQ” is used for the geographic zone “R” when it is shifted to time zone “Q”. The lower and upper case usage de-emphasizes the geographic zone while capitalizing the time zone that is set, since that is the element that is used when translating between global time. The second use of letter pairs is to designate whether or not a local time zone is ahead or behind by one whole day, as indicated by the prefixed letters “y” and “z” respectively, from the geographically designated time zone, as happens on either side of the International Dateline. The third use of letter pairs is to designate those local time zones that use a special rule that offsets the local hour from the global hour by a fractional amount, most commonly thirty minutes. For example, the letter pair “gh” is used to designate a local time zone that uses a fractional offset that is halfway between zone “G” and zone “H”. Fractional offset zones are designated without a capital letter to signify that the local time cannot be translated between global time by transposition of the hour alone. The minutes must be translated as well.

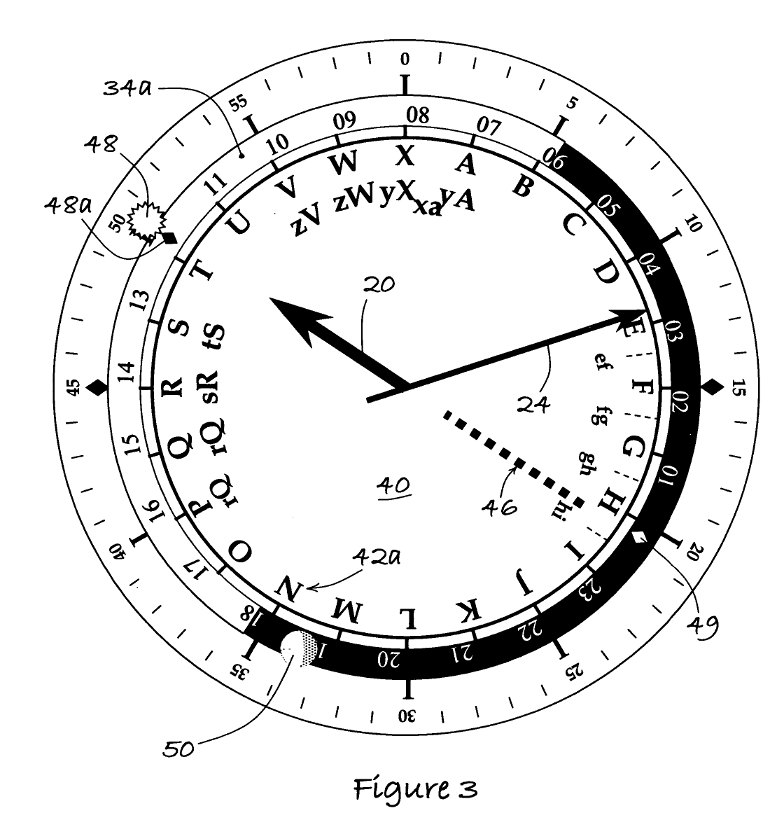

FIG. 3 is a graphical representation of another embodiment of a 24-hour clock face 10 with the local time scale 34a marked with daytime and nighttime hours. Additionally, in this embodiment the local time scale rotates with the hour hand 20 to show the local time at all zones simultaneously. Also coupled to the hour hand rotation is an optional midnight pointer 46 (dashed line) that basically is an extension of the end of the hour hand 20 that extends toward the midnight index 49 in the local time scale 34a. The midnight pointer 46 serves to indicate transition from one day to the next. Another significant feature of FIG. 3 is that global time scale 42a is now oriented with the global letter-hour “X” at the top, coinciding with the International Dateline to give no special orientation to any other particular local time zone. In this embodiment, the inner ring/circle 40 with the global time scale 42a is stationary and does not move. The sunn symbol 48 is fixed relative to the local time scale 34a at noon index 48a and moves as an extension of the hour hand. The optional Moon symbol 50 is disposed (with the appropriate clock/watch driver, especially for LCD-type embodiments) to move independently, correlated to the Moon's motion with respect to the Earth by making a complete rotation through the moving local time scale 34a once every lunar month, roughly twenty-nine and a half days.

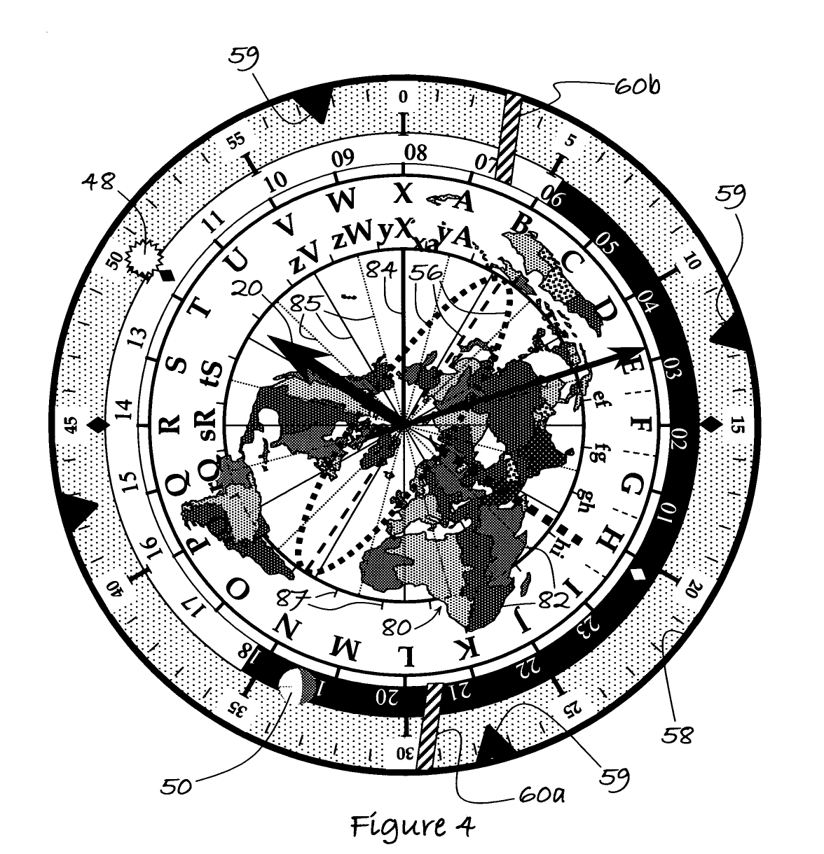

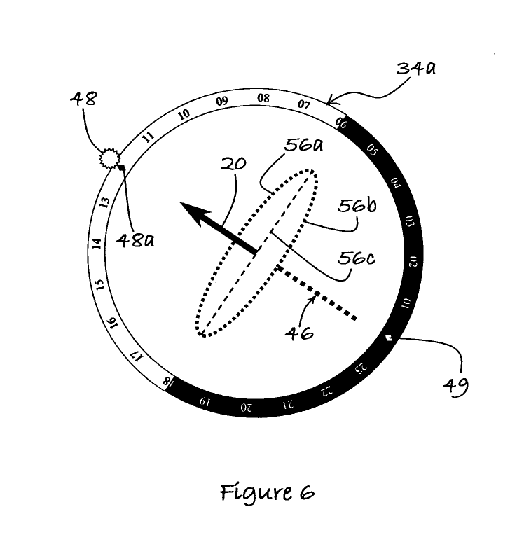

The preferred embodiment of FIG. 4 is similar to FIG. 3, but with the addition of a non-moving North Polar projection map 80 of the globe centered on the clock face 10 oriented with the International Dateline 84 corresponding with the letter “X” at the top. Each time zone is graphically represented by central lines 85 radiating from the North Pole located at the center of the map 82 as well as bordering lines 87 along with the zoned land masses 82 depicted on the map. The moving hour hand 20 with midnight pointer 46 has an additional element of a day/night “terminator” symbol 56 that indicates the limit of the Sun's rays as it varies from the solstices to the equinoxes as shown as a dashed ellipse 56a & 56b and straight line 56c respectively (see FIG. 6). The addition of an optional adjustable bezel 58 having four quadrant markers 59 indicates noon, 6 pm, midnight, and 6 am in one particular local time zone. Additionally shown are optional local sunrise 60a and sunset 60b markers (bars) that move slowly through the year in correlation with changing sunrise/sunset times. Sunrise/sunset markers 60a & 60b for a particular city are disposed so that the sunn marker 48 reaching them indicates sunrise and sunset respectively.

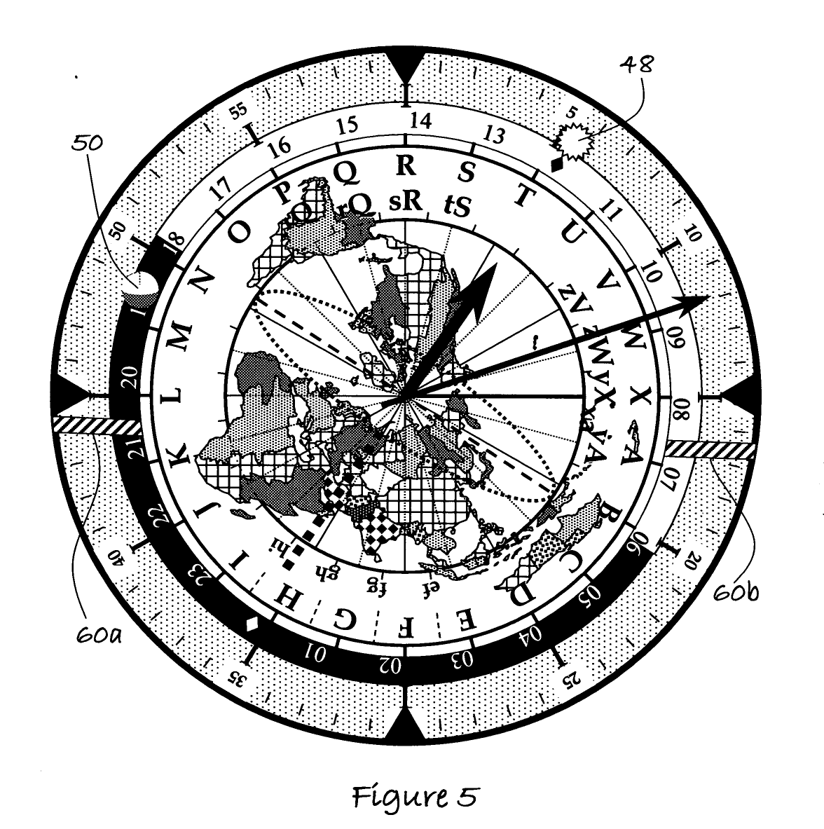

The embodiment of FIG. 5 is similar to that of FIG. 4, but showing in this example the local noon “R” for the CST time zone oriented at the top (“twelve o'clock position”) of the clock face. FIG. 6 depicts the features or elements of FIGS. 4 & 5 that move in unison with the hour hand 20. These features include the local time hour scale 34a with the sunn symbol 48 fixed at the noon index 48a and the midnight pointer 46 toward the midnight index 49, and the terminator lines 56 indicating day/night demarcation for the northern hemisphere at solstices and equinoxes.

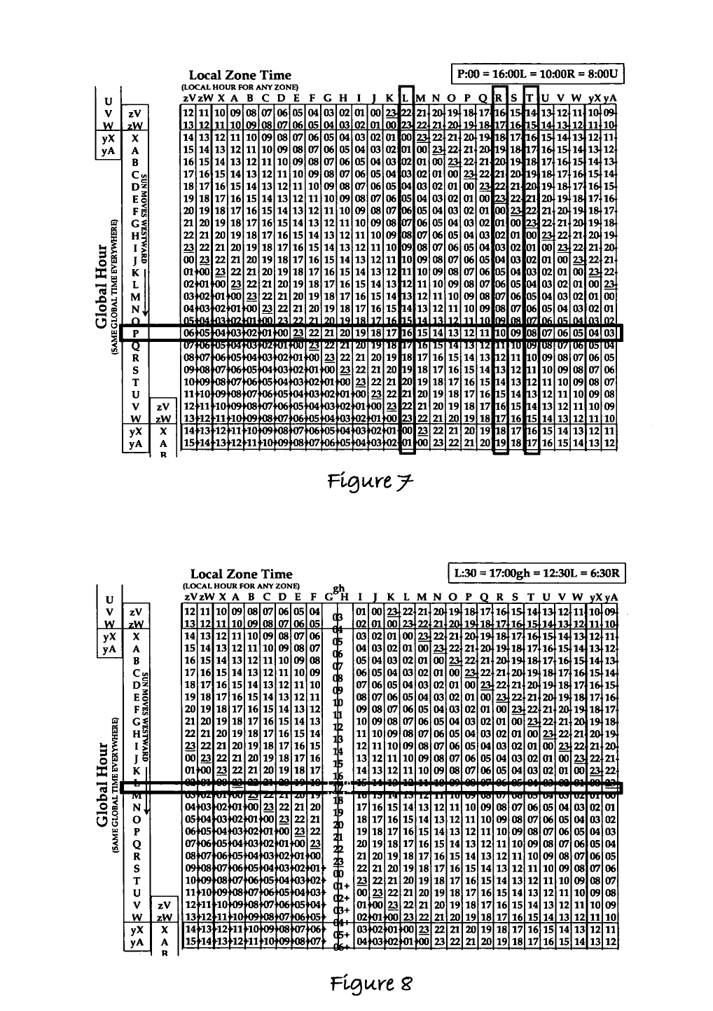

FIG. 7 depicts a table of local hours for a given day as indexed from a left-hand column of global hours as defined by the sunn symbol's position relative to a span of local time zones running left to right. This table serves as a conversion chart to illustrate how global time equates to various local times. FIG. 8 depicts the local/global conversion chart with a particular local time zone that is offset by a half hour between zones “G” and “H” (designated as zone “gh”, using two lower case letters to distinguish it from zones using global standard minutes). Among other countries that use a half hour offset, this particular zone conforms to local time used throughout India.

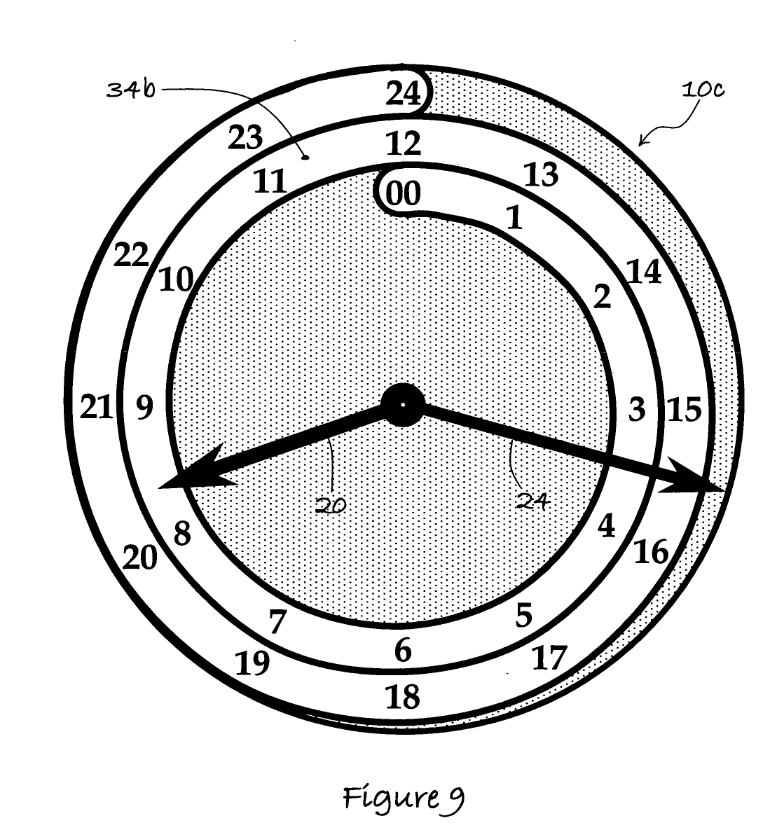

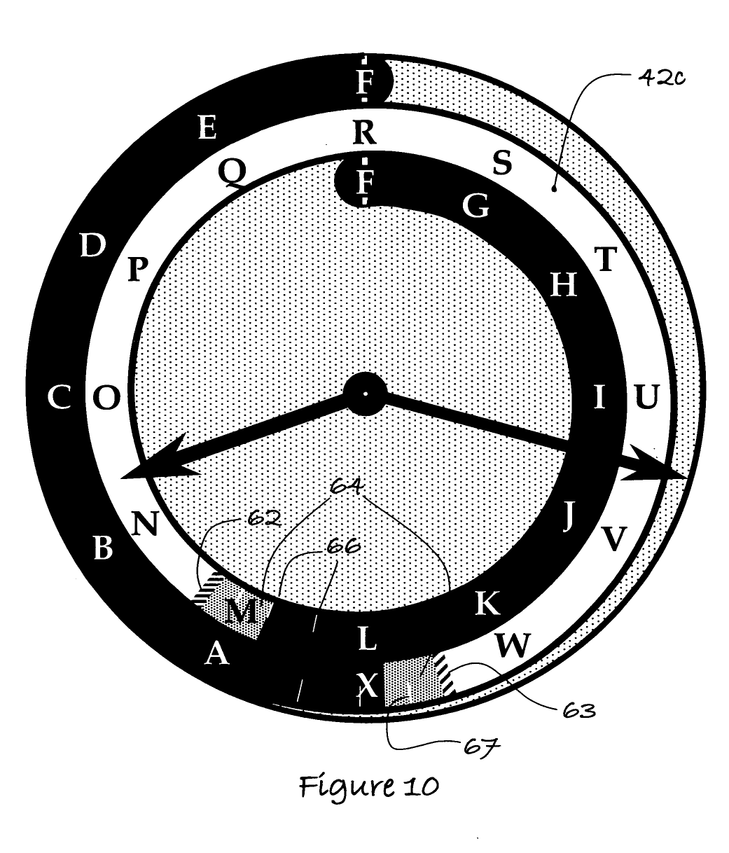

FIG. 9 depicts an embodiment of the present clock face 10c for use with a standard 12-hour clock mechanism. The clock face 10c has a spiraled scale of the 24 hours in one day, with the individual hours being designated by the standard 24-hour numeric progression used to represent local time. FIG. 10 is similar to FIG. 9 except that local numeric hour scale 34b is replaced by global letter-hour scale 42c. In the case shown, the global letter-hour scale 42c is disposed with reference to noon for CST local time, i.e., with “R” at the top 12 o'clock position. Also added is shading to distinguish day hours from night hours and to indicate sunrise 62 and sunset 63 as well as periods of civil twilight 64. Indices for sunrise 66 and sunset 67 indicate the times for such events as they shift throughout the seasons.

Clock faces 10 may be changed as necessary by any of a number of means known to and selectable by one of ordinary skill in the art. For example, standard time and saving time may be changed over by swapping out printed clock face inserts scaled as appropriate for the desired geographical region (e.g., the USA), with sunrise/sunset markers 62 & 63 for a particular city. Alternatively, changing or resetting the clock in such a case can be accomplished electronically by the use of an appropriate digital display of the hour characters, e.g., using an LCD clock face with selectable displays that can have dynamic indication of sunrise/sunset markers 62 & 63 as well as dynamic indicators for civil twilight 64.

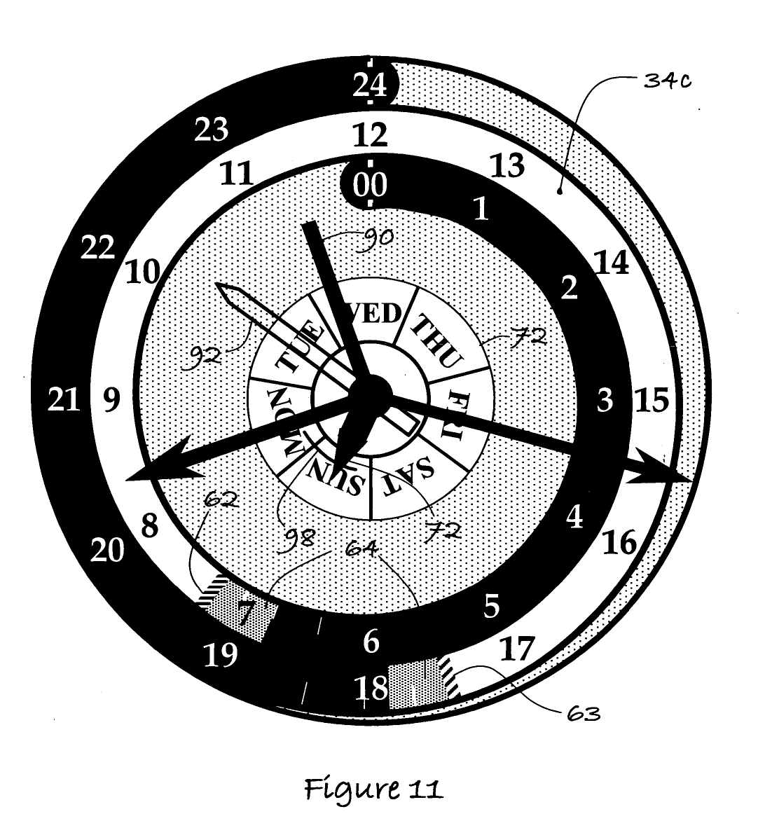

FIG. 11 is similar to FIG. 10 except that local number-hours are used on the local hour ring 34c instead of global letter-hours. FIG. 11 also includes two extra hour hands 90 & 92 to indicate the local hour for two other time zones. Once set to their respective time zone indications, all three hour hands move in unison. Additionally, FIG. 11 includes a centrally located day-of-the-week pointer 70 that makes one full clockwise rotation once each week through a dial 72 to indicate each of the seven days of the week. Fixed to this pointer is an arc 98 that broadly spans the local day for all time zones across the globe.

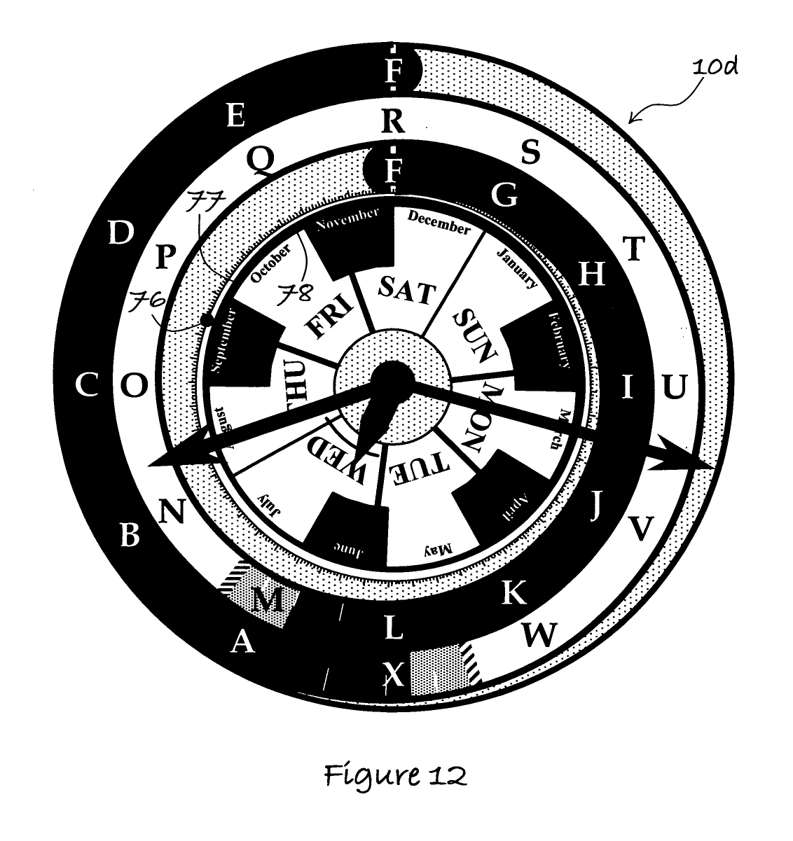

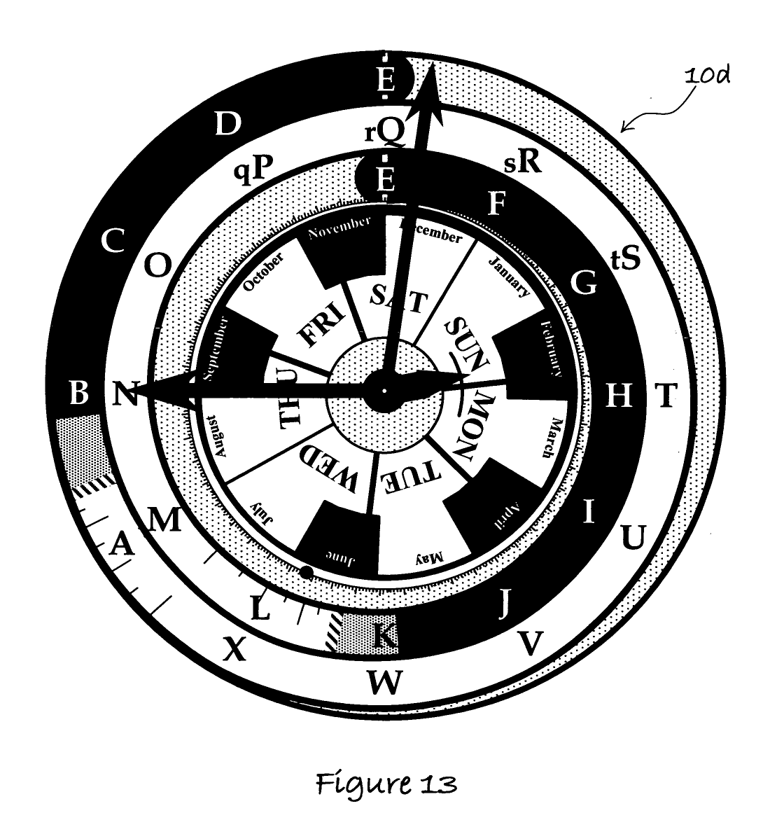

FIG. 12 is similar to FIG. 10, but with the addition of an annual calendar ring 78 showing months of the year with an Earth symbol 76 that is displayed in concert with the day-of-the-week indicator similar to that shown in FIG. 11. With the appropriate clock mechanism driver, the earth symbol 76 makes one full clockwise rotation every year, stepping through a circle that is hash-marked to indicate days and weeks. This circle is also marked with a “day/night ratio” disk 77 to indicate the increase of daylight hours during summer months and the decrease of daylight hours during the winter. The position of the Earth symbol 76 with respect to the day/night marking displays the season, with the edge of the Earth symbol meeting the edge of the “day/night ratio” marking during equinox. The twelve months of the year are displayed with the seven days of the week combined in a graphic analog to the twelve musical semitones, similar to the black and white keys found on a piano. The months that have 31 days correspond to the white keys while the months that have less than 31 days correspond to the black keys. The months are also oriented so that January, as the first month of the year, corresponds to the 1 o'clock position, February with 2 o'clock, and so on. This way, the name of the month does not need to be read. If the Earth symbol 76 is located in the 11 o'clock region, then it is indicating the eleventh month of the year. Other markings can be added to all hour, week and/or year scales to indicate special events, such as a birthday celebration. FIG. 13 is similar to FIG. 12, except that the clock face 10d is adjusted for Central Daylight Time, as is practiced in the United States throughout the summertime.

The present time standard being oriented to the International Dateline yields the convenient consequence whereby global letter-hours correspond to GMT wherein the first letter, “A”, translates to the first GMT hour, and so on, as indicated in the following:

| | |
|---|---|
| A:21 = 0121 GMT | (with: first letter “A” = first GMT hour 0100) |
| B:43 = 0243 GMT | (with: second letter “B” = second GMT hour 0200) |
| . | |
| . | |
| . | |
| P:54 = 1654 GMT | . . . |
| Q:36 = 1736 GMT | |
| R:11 = 1811 GMT | |
| . | |
| . | |
| . | |
| V:30 = 2230 GMT | . . . |
| W:59 = 2359 GMT | |
| X:01 = 0001 GMT | |

Likewise fitting into this straightforward pattern, the twelfth letter, “L”, as associated with the time zone at zero degrees longitude, translates to local twelve o'clock noon at Greenwich (global letter-hour “L” equals 1200 GMT). Such a simple conversion can serve to facilitate the adoption of the present time standard in a switch over from the broadly used, but often confused, standard of UTC (as based upon GMT).

Further refinements are included in the global time standard of the present invention. A local time is designated as being a day ahead or a day behind the majority of the planet by inserting either a “+”or “−”, respectively (with the term “majority” being used here in a geographical sense to specify more than half of the Earth's surface, and not necessarily more than half of the Earth's population). For example:
K:21=01:21+zV=11:21 L=23:21−yA

For the case above, if it is Sunday in Switzerland at 11:21K local, it is simultaneously Monday in the “zV” zone as well as Saturday in the “yA” zone. Dates are written with unambiguous notation so that months are designated with a single hatch mark (′) and days are designated with a double hatch mark (″), similar to how primary and secondary divisions are designated for length to indicate feet and inches. Examples of this Date-Time Group standard:
K:21 11′14″2004 indicates a Date-Time Group for Nov. 14^{th}, 2004.

Alternate sequences for year, month and day remain unambiguous by using this standard. Examples:
2004 11′14″
14″11′04

Date-Time designations using local time instead of global time use the “equals”, “plus” and “minus” symbols (=, +, −) to respectively indicate whether the local date is the same as, ahead of, or behind the majority of the planet. Examples:

| | |
|---|---|
| 01:21zV + 11'15”2004 | (the “+” indicates that the date for the majority |
| | of the planet is 11'14”2004) |
| 11:21 L = 11'14”2004 | (the “=” indicates that the date in zone “L” is |
| | the same date as the majority) |
| 23:21yA − 11'13”2003 | (the “−“ indicates that the date in zone “yA” is |
| | one behind the majority) |

Further specification of the present standard is made for the indication of the days of the week to reflect the fact that at any and all moments in time, the Earth as a whole is experiencing at least two days simultaneously. Global days can be indicated with a two-letter abbreviation taking the first letters from the day-names “Sunday”, “Monday”, “Tuesday”, “Wednesday”, “Thursday”, “Friday” and “Saturday”. (While a set of single letter abbreviations for this group of day-names is ambiguous in the English language, there is no such problem when taking the combination of sequential days, as occurs physically across the globe at any and all moments.)

The present standard for indicating global days of the week uses the first letters of the two sequential days that are simultaneously existing at all twenty-four geographic time zones for the specific moment in time of a particular Date-Time Group. Upper case designations are used in the abbreviation of global days to indicate which day of the week is associated with the majority of the planet, with the complimentary lower case designation used to indicate the day of the week that is not associated with the majority.

The present standard specifies a sequence of local days for each time zone as they translate co-operatively with the set of fourteen global days. One method for implementing this standard is to indicate a three-letter abbreviation for the local day of the local zone, coupled with a one-letter abbreviation of the complimentary day of the week that is simultaneously occurring in one or more of the other twenty-four standard time zones. This one-letter abbreviation is either prepended to the local day abbreviation, or concatenated at the end of such, so that the days of the week are indicated in proper left-to-right sequence. A letter-case coding method can be used to designate DTGs by using upper-case letters for such times when the local day coincides with the day being experienced by the majority of the planet, and lower-case letters used when not coinciding with the majority. Therefore, the present standard specifies a set of twenty-one local day DTG designations that work co-operatively with the set of fourteen standard global days that occur in every week. An example of a complete sequential set of global and local day abbreviations that conforms to the present standard is listed below:

| GLOBAL | LOCAL | LOCAL |
|---|---|---|
| DAY&ABBR: | ABBRV: | DAY: |
| Sm | SUNm | Sunday |
| sM | sunM → sMON | Sunday → transition to Monday |
| Mt | MONt | Monday |
| mT | monT → mTUE | Monday → transition to Tuesday |
| Tw | TUEw | Tuedsay |
| tW | tueW → tWED | Tuesday → transition to Wednesday |
| Wt | WEDt | Wednesday |
| wT | wedT → wTHU | Wednesday → transition to Thursday |
| Tf | THUf | Thursday |
| tF | thuF → tFRI | Thursday → transition to Friday |
| Fs | FRIs | Friday |
| fS | friS → fSAT | Friday → transition to Saturday |
| Ss | SATs | Saturday |
| sS | satS → sSUN | Saturday → transition to Sunday |

The present invention using this co-operatively interacting global and local time standard has embodiments of digital clocks as well as analogue clocks with 24-hour and 12-hour faces. Clock movements, both 24-hour and 12-hour are well known in the field and are commercially available for practice with the present invention. Digital clocks using the present standard may simply display global time along with any number of local times. The following is an exemplary set of characters that can be displayed on a digital clock to show global time along with the local times from two different zones:
N:52
18:52H
13:52M
   Redundant minute indication can be eliminated for efficiency with the following exemplary compact indication:
N18:52H/13M

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

1. A global time reckoning system for translating between local time and global time that simultaneously indicates local time and global time, the global time reckoning system comprising:
a timer driver operating the changeable components of a global time system clock face; and
a global time system clock face having time indicating means, the time indicating means including an hour indicating means, a minute indicating means, and a global time zone indicating means.

2. The global time reckoning system of claim 1, wherein the timer driver is selected from the group of timer drivers consisting of: 24-hour clock timer drivers, and 12-hour clock timer drivers.

3. The global time reckoning system of claim 2, wherein the timer driver further comprises means for driving the hour indicator, the minute indicator, and a time related indicator selected from the group consisting of: a seconds indicator, a day indicator, a date indicator, a week indicator, a lunar time indicator and a sunrise/sunset indicator.

4. The global time reckoning system of claim 3, wherein the timer driver comprise a clock motor and the indicators are rotatable by the timer driver.

5. The global time reckoning system of claim 3, wherein the timer driver comprises a digital display driver and the indicators are digitally displayed by the timer driver.

6. The global time reckoning system of claim 1, wherein the global time clock face comprises a clock face selected from the group of clock faces consisting of: an analogue clock face, a digital clock face, and a combination analogue and digital clock face.

7. The global time reckoning system of claim 1, wherein the time indicating means of the global time system clock face has local hour indicating means consisting essentially of a 24-hour time scale, and global time zone indicating means consisting of a global time zone scale having twenty-four major divisions in combination with an hour hand driven by the timer driver.

8. The global time reckoning system of claim 1, wherein the minute indicating means of the time indicating means of the global time system clock face consisting essentially of a minute time scale in combination with a minute hand driven by the timer driver.

9. The global time reckoning system of claim 7, wherein the global time system clock face comprises a rotating time indicating means with the local 24-hour scale outside of and concentric with the global time zone scale with the global time zone scale rotating in sync with the hour indicator of the rotating time indicating means.

10. The global time reckoning system of claim 7, wherein the global time system clock face comprises a rotating time indicating means with the local 24-hour scale outside of and concentric with the global time zone scale with the local 24-hour scale rotating in sync with the hour indicator of the rotating time indicating means.

11. The global time system clock face of claim 7, wherein the local 24-hour scale is rendered using an ordered set of numerals and the global time zone scale is rendered using an ordered set of non-numerals.

12. The global time system clock face of claim 7, wherein the local 24-hour scale is rendered using an ordered set of twenty-four numerals and the global time zone scale is rendered using an ordered set of twenty-four western alphabetical characters.

13. The global time system clock face of claim 7, wherein the local 24-hour scale is rendered using an ordered set of twenty-four Arabic numerals from 1 to 24 and the global time zone scale is rendered using an ordered set of twenty-four western alphabetical characters from “A” to “X”.

14. The global time reckoning system of claim 7, wherein the global time system clock face comprises a rotating time indicating means with the local 24-hour scale outside of and concentric with the global time zone scale with the local 24-hour scale rotating in sync with the hour indicator of the rotating time indicating means, and the local 24-hour scale is rendered using an ordered set of numerals and the global time zone scale is rendered using an ordered set of non-numerals with the first non-numeral of the ordered set is rendered at the 12:00 o'clock position on the clock face to provide a clock face giving no special status to any one particular time zone.

15. A global time reckoning system for indicating local time, the global time reckoning system comprising:
a 12-hour timer driver operating the changeable components of a global time system clock face; and
the global time system clock face having time indicating means, the time indicating means including an hour indicating means and a minute indicating means, and a spiraled time scale with markings for events that occur during the indicated period of time.

16. The global time system clock face of claim 15, further comprising markings to indicate the hours of the day.

17. The global time system clock face of claim 15, further comprising markings to distinguish daylight hours from nighttime hours.

18. The global time system clock face of claim 15, further comprising markings to indicate the times of sunrise and sunset.

19. A 12-hour analog clock face that associates the division of time with the division of a musical scale.

20. The 12-hour analog clock face of claim 19, wherein the 12 months of the year are associated with the 12 hours of the half-day.
